(19) United States
(12) Patent Application Publication
(10) Pub. No.: US 2011/0064269 A1
(43) Pub. Date: Mar. 17, 2011

(54) OBJECT POSITION TRACKING SYSTEM AND METHOD

(75) Inventors: Manohara PAI M.M, Karnataka (IN); Vijay S. Rajpurohit, Karnataka (IN)

(73) Assignee: MANIPAL INSTITUTE OF TECHNOLOGY, Karnataka (IN)

(21) Appl. No.: 12/627,709

(22) Filed: Nov. 30, 2009

(30) Foreign Application Priority Data
Sep. 14, 2009 (IN) 2225/CHE/2009

(51) Int. Cl. G06K 9/00; G06N 7/02

(52) U.S. Cl. 382/103; 706/47; 706/52

(57) ABSTRACT

A method of tracking an object is provided. The method includes obtaining sensed positions of the object at a plurality of time instants and predicting a future position of the object by applying fuzzy predictive rules to the sensed positions of the object obtained from at least two previous time instants.

### CROSS REFERENCE TO RELATED APPLICATIONS

This application claims priority to Indian Patent Application Serial No. 2225/CHE/2009 filed Sep. 14, 2009, the contents of which are incorporated by reference herein in its entirety.

### BACKGROUND

Motion prediction of objects is required in robot navigational environments such as in hazardous environments and other environments. Typically in a robot navigational environment, the robot has to move in either indoor or outdoor environments while avoiding any obstacles in the navigation path. Therefore, it is desirable that the robot is capable of obtaining information about the environment.

To obtain such information, several techniques have been employed. For example, the robot may be equipped with sensors such as laser range finders, sonar array sensing devices, ultrasonic sensors or stereo vision sensors to obtain the position information of objects in the navigation environment. However, these techniques can be intrusive and therefore are not suitable for use in environments with humans. For example, light detection and ranging (LIDAR) techniques may be employed to obtain position information. However, LIDAR techniques rely on transmission of infrared light that can be dangerous to the human eye beyond nominal power settings.

Further, in dynamic navigation systems, it is desirable to obtain the information about moving objects and predicting their future positions to facilitate planning of the navigation path. Certain systems utilize regression methods for position prediction that sample the positions of the moving object at definite time intervals and fit the information in a regression equation for future position prediction. However, this requires estimation of model coefficients in a real time environment, thereby increasing the complexity of such systems.

Certain other systems employ statistical methods such as a hidden Markov model to predict object position. Unfortunately, such methods are substantially computationally intensive and may not be able to model real time situations.

### SUMMARY

Briefly, in accordance with one aspect, a method of tracking an object is provided. The method includes obtaining sensed positions of the object at a plurality of time instants and predicting a future position of the object by applying fuzzy predictive rules to the sensed positions of the object obtained from at least two previous time instants.

In accordance with another aspect, a method of tracking an object is provided. The method includes generating a plurality of fuzzy predictive rules using sensed positions of the object at a plurality of time instants and optimizing the plurality of fuzzy predictive rules by altering or removing at least one of missing fuzzy predictive rules, conflicting fuzzy predictive rules, circular fuzzy predictive rules and redundant fuzzy predictive rules to generate optimized fuzzy predictive rules. The method also includes obtaining first and second sensed positions of the object at first and second time instants and predicting the position of the object at a third time instant by applying the optimized fuzzy predictive rules to the first and second sensed positions.

In accordance with another aspect, an object position tracking system is provided. The object position tracking system includes a sensing device configured to obtain a plurality of sensed positions of an object in an environment and a memory circuit configured to store a plurality of fuzzy predictive rules for estimation of future positions of the object based upon the sensed positions. The object position tracking system also includes a processor configured to predict the future position of the object by applying the fuzzy predictive rules to sensed positions of the object for at least two previous time instants.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic diagram of an illustrative embodiment of an object tracking system.

FIG. 2 shows an example flow diagram of method of tracking an object using the object position tracking system of FIG. 1.

FIG. 3 is an illustrative polar position map of a navigation space of the object of FIG. 1.

FIG. 4 illustrates distance range and angle inputs of an object at a first time instant (t1) before fuzzification of such inputs.

FIG. 5 illustrates distance range and angle inputs of an object at the first time instant (t1) after fuzzification of such inputs.

FIG. 6 illustrates distance range and angle inputs of an object at a second time instant (t2) before fuzzification of such inputs.

FIG. 7 illustrates distance range and angle inputs of an object at the second time instant (t2) after fuzzification of such inputs.

FIG. 8 is an illustrative embodiment of a fuzzy Petri net model for position prediction of the object using the object position tracking system of FIG. 1.

FIG. 9 illustrates an example of a reachability graph for the navigation space of FIG. 1 generated using the static Petri net model.

FIG. 10 illustrates another reachability graph of the navigation space for identifying conflicting fuzzy predictive rules.

FIG. 11 illustrates another reachability graph of the navigation space for identifying redundant fuzzy predictive rules.

FIG. 12 illustrates a partitioned navigation space that is tessellated in eight geographical directions.

FIG. 13 is a table of antecedents and consequents for six fuzzy predictive rules with the distance range and angle values.

FIG. 14 is a table of antecedents and consequents for six fuzzy predictive rules with the distance range and angle values along with corresponding degrees.

FIG. 15 is a table with reliability factors estimated for the inconsistent and redundant rules.

FIG. 16 is a block diagram illustrating an example computing device that is arranged for short term motion prediction in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Example embodiments are generally directed to tracking of objects in an environment. Such techniques may be useful in a variety of applications such as for short term motion prediction in robot navigational environments such as hazardous environments and other environments that require efficient, reliable, cost-effective, and real-time monitoring of movement of objects. Although examples are provided herein in the context of robot navigational environments, one of ordinary skill in the art will readily comprehend that embodiments may be utilized in other contexts.

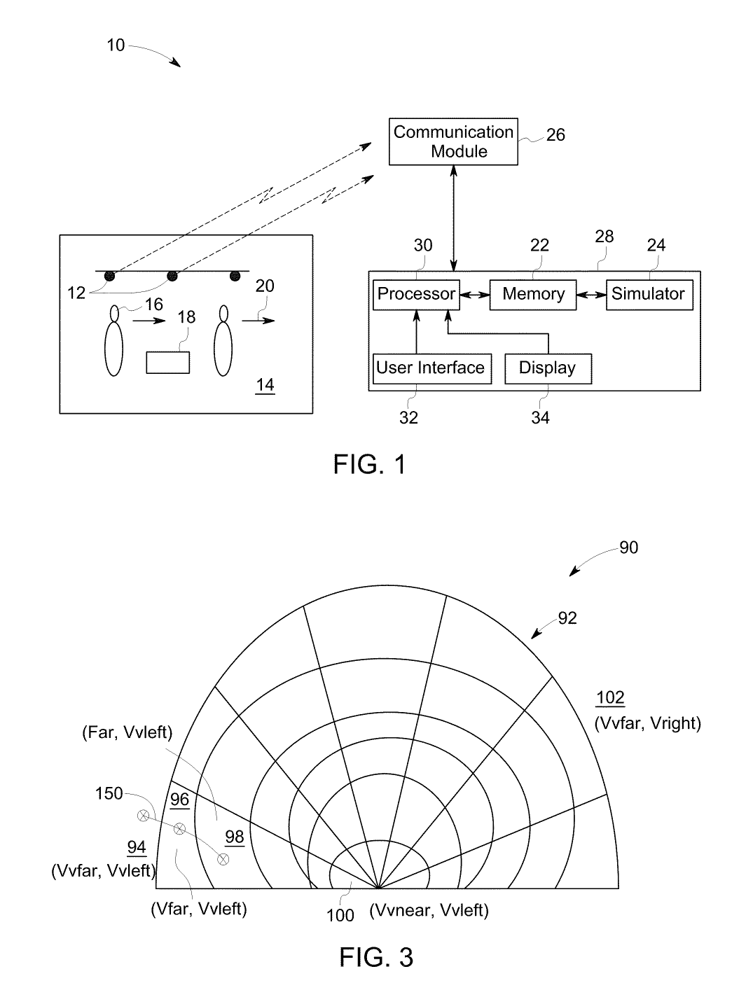

Referring now to FIG. 1, a schematic diagram of an object tracking system 10 is illustrated. The system 10 includes a sensing device such as represented by reference numeral 12 located in an environment 14. The sensing device 12 is configured to obtain a plurality of sensed positions of an individual 16 or any other object 18 in the environment 14. A plurality of such sensing devices 12 may be disposed in plurality of locations within the environment 14. The sensing device 12 is configured to monitor and track the movement of one or more individuals 16 and/or objects 18 as they move within the environment 14. In certain embodiments, the sensing device is disposed on the object 18. It should be noted that the individual 16 and/or the object 18 may move in various directions with different velocities within the environment 14. In the illustrated embodiment, an example direction of the movement of the individual and/or object 18 is represented by reference numeral 20.

In the illustrated embodiment, the sensing device 12 includes a stereo vision based sensor. In certain embodiments, the sensing device 12 may include a network of still or video cameras or a closed circuit television (CCTV) network. However, a variety of other position sensing devices may be employed to obtain the position of the individual 16 and/or object 18. For example, range finders, sonar array sensing devices and ultrasonic sensors may be employed to obtain the position. Certain position sensing devices may include data exchange components such as a transmitter and a receiver to sense the position of the individual 16 and/or object 18. Such sensed positions are utilized to predict the future position of the individual 16 and/or object 18 by using fuzzy predictive rules as described in a greater detail below.

The object position tracking system 10 further can include a memory circuit 22 configured to store a plurality of fuzzy predictive rules for estimation of future positions of the individual 16 and/or object 18 based upon the sensed positions. The memory circuit 22 may include hard disk drives, optical drives, tape drives, random access memory (RAM), read-only memory (ROM), programmable read-only memory (PROM), Redundant Arrays of Independent Disks (RAID), flash memory, magneto-optical memory, holographic memory, bubble memory, magnetic drum, memory stick, Mylar® tape, smartdisk, thin film memory, zip drive, and so forth. The memory circuit 22 is further configured to store the sensed positions of the individual 16 and/or object 18, and other data or code to predict the position of the individual 16 and/or object 18 at future time instants.

In certain example embodiments, the object position tracking system 10 can include a simulator 24 configured to receive the sensed positions of the individual 14 and/or object 16 at the plurality of time instants from the sensing device 12 and to generate a plurality of fuzzy predictive rules based upon the sensed positions. Such fuzzy predictive rules are subsequently can be stored in the memory circuit 22. In the illustrated embodiment, the object tracking system 10 further includes one or more communication modules 26 disposed in the environment 14, and optionally at a remote location, to transmit sensed positions of the individual 16 and/or the object 18 to the simulator 24 and the memory circuit 22 disposed within the environment 14 or at a remote location 28.

The communication modules 26 may include wired or wireless networks, which communicatively link the sensing device 12 to the memory circuit 22 and to the simulator 24. For example, the communication modules 24 may operate via telephone lines, cable lines, Ethernet lines, optical lines, satellite communications, radio frequency (RF) communications, and so forth. The object position tracking system 10 further can include a processor 30 configured to predict the future position of the individual 16 and/or the object 18 by applying the fuzzy predictive rules to sensed positions of the individual 16 and/or the object 18 for at least two previous time instants. In certain embodiments, the processor 30 is configured to refine the fuzzy predictive rules by altering or removing at least one of missing fuzzy predictive rules, conflicting fuzzy predictive rules, circular fuzzy predictive rules and redundant fuzzy predictive rules.

Depending on the desired configuration, processor 30 can be of any type including but not limited to a microprocessor (μP), a microcontroller (μC), a digital signal processor (DSP), or any combination thereof. Processor 30 can include one more levels of caching, such as a level one cache and a level two cache, a processor core, and registers. The processor core can include an arithmetic logic unit (ALU), a floating point unit (FPU), a digital signal processing core (DSP Core), or any combination thereof. A memory controller (not shown) can also be used with the processor 30, or in some implementations the memory controller can be an internal part of the processor 30.

Further, the object position tracking system 10 may include a variety of software and hardware for predicting the position of the individual 16 and/or the object 18 at different time instants. For example, the object position tracking system 10 may include file servers, application servers, web servers, disk servers, database servers, transaction servers, telnet servers, proxy servers, list servers, groupware servers, File Transfer Protocol (FTP) servers, audio/video servers, LAN servers, DNS servers, firewalls, and so forth.

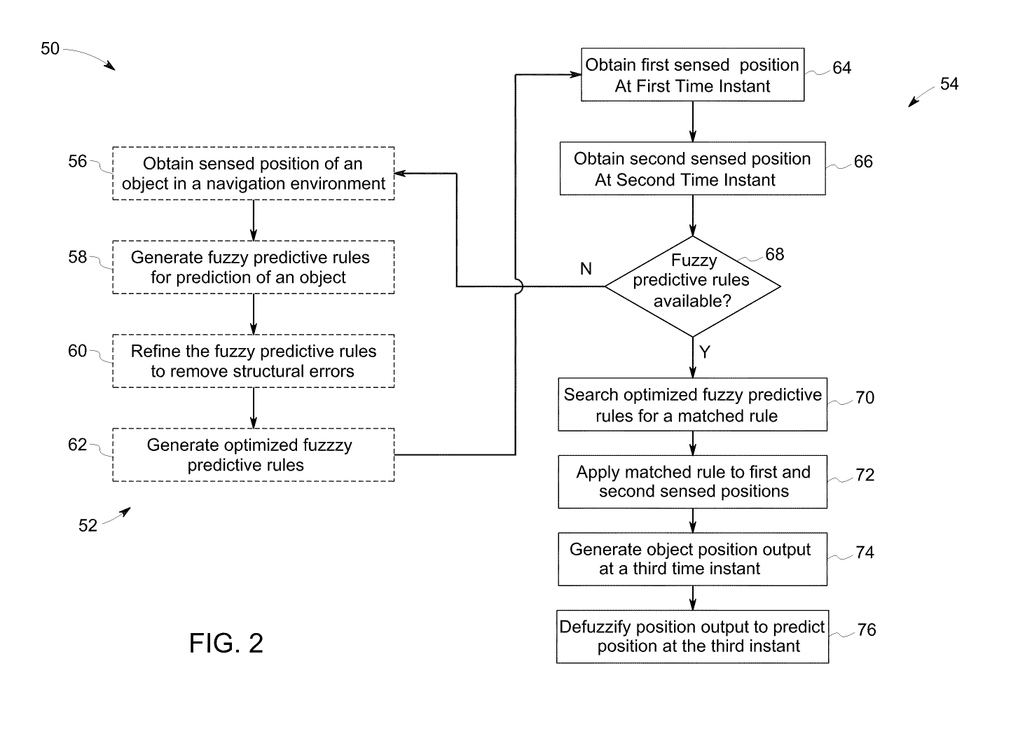

The object tracking system 10 further includes a user interface 32 that enables users, system administrators and computer programmers to communicate with the memory circuit 22, simulator 24 and the processor 30. For example, the user interface 32 may be utilized by a user to provide inputs to the simulator 24 for generating the fuzzy predictive rules for motion prediction. Moreover, the system 10 includes a display 34 configured to display predicted position of the individual 16 and/or the object 18 at the plurality of time instants. The generation of the fuzzy predictive rules and the application of such rules to predict future position of the individual 16 and/or the object 18 will be described with reference to FIGS. 2-8.

FIG. 2 shows an example flow diagram 50 of an embodiment of a method of tracking an object using the object position tracking system 10 of FIG. 1. The method 50 includes establishing fuzzy predictive rules for the environment, generally represented by process steps 52. Further, the method includes using such rules for predicting the position of the object in the environment, generally represented by process steps 54.

At block 56, sensed positions of the object are obtained at a plurality of time instants. For example, first, second and third sensed positions of the object in a navigation space at first, second and third time instants are obtained. In one embodiment, the navigation space is observed using stereo vision based sensors. A depth map of the navigation space is created that provides a gray scale image of the environment. The ground surface may be removed subsequently and an object of interest may be reconstructed from the gray scale image of the environment. Furthermore, a distance range and an angle of the object with reference to the sensor device are obtained at each of the first, second and third time instants. In other applications, and depending upon the sensing systems utilized, such image-based analysis techniques may be omitted, and location information may be determined from the sensor information acquired.

In one embodiment, the navigation space includes a semi-circular area in front of the sensing device. The navigation space is partitioned into a plurality of fuzzy subsets based upon the distance range and the angle of the object to develop a polar position map of the navigation space. It should be noted that the analysis may be based on full plane mapping (e.g., a full circle in a plane), or on three-dimensional mapping. Each of the first second and third sensed positions is characterized by a distance range and an angle of the object in the polar position map. Such fuzzy subsets are utilized to generate fuzzy predictive rules from the sensed positions. At step 58, a plurality of fuzzy predictive rules are generated from sensed positions of the object at a plurality of time instants. In this embodiment, the fuzzy predictive rule is generated using the first and second sensed positions as antecedents and the third sensed position as a consequent of the fuzzy predictive rule. An example of the fuzzy predictive rule is represented below by Equation (1):

[symbol]

1)

where:

t₁ and t₂ represent two substantially equal time instants at which the object is observed; and

t3 represents the time instance at which the position of the object is predicted.

A plurality of such fuzzy predictive rules may be generated based upon sensed object positions. Further, a user may define additional fuzzy predictive rules based upon his/her domain knowledge and technical expertise.

At block 60, the fuzzy predictive rules are refined by eliminating structural errors in the rules. Examples of structural errors include, but are not limited to, missing fuzzy predictive rules, conflicting fuzzy predictive rules, circular fuzzy predictive rules and redundant fuzzy predictive rules. In one embodiment, the fuzzy predictive rules are characterized using fuzzy Petri nets and the structural errors may be identified using such fuzzy Petri nets. The graphical nature of the Petri nets is utilized to model sequences of firing via token passing over the nets. A Petri net includes a number of places and transitions with tokens distributed over places. Further, arcs are used to connect transitions and places. Once input place of a transition contains a token, the transition is enabled and may fire. Further, the result of firing a transition is that a token from every input place is consumed and a token is placed into every output place.

In an embodiment, a static analysis Petri net model is employed to characterize the fuzzy predictive rules and is represented by the following equation:

[symbol]

(2)

where:
(P, T, F) is the Petri net structure;
P and T are nonempty sets satisfying [symbol] ;
P is the set of places;
T is the set of transition;
[symbol] is a flow relation
W is a mapping from [symbol] ; and
M: [symbol] is an initial marking that assigns 0 (no token) or w (any number of tokens) to each predicate in P.

The structural errors are identified in the fuzzy predictive rules through the fuzzy Petri nets representing the rules. In an embodiment, at least one of missing fuzzy predictive rules, conflicting fuzzy predictive rules, circular fuzzy predictive rules and redundant fuzzy predictive rules is identified via a reachability graph of the fuzzy Petri nets. Further, such identified conflicting and redundant fuzzy predictive rules are then removed by selectively partitioning the navigation space of the object or by using a reliability factor in a table-lookup operation to generate the optimized fuzzy predictive rules (block 62). The optimized fuzzy predictive rules may be utilized to predict the position of the object at future time instants as described below.

It should be noted that in an example embodiment the generation of the fuzzy predictive rules may be performed independently of the motion prediction of the object and such rules may be stored for future prediction of the position of the object in the navigation space. However, new rules can be added or existing rules may be modified even during the position prediction phase based upon additional sensed positions and/or through a user input.

At block 64, a first sensed position of the object at a first time instant is obtained. At block 66, a second sensed position of the object at a second time instant is obtained. In an embodiment, the first and second time instants are substantially equally spaced in time. In one embodiment, a stereo-vision based sensor may be employed to obtain the position of the object. Further, at block 68, it is verified that the fuzzy predictive rules are available. If the fuzzy predictive rules are required to be generated and/or refined, the process steps 52 are followed as described above.

In an embodiment, the fuzzy predictive rules are then searched for a matched rule to predict the position of the object at a third time instant using the first and second sensed positions (block 70). Further, the matched rule is applied to the first and second sensed positions to generate a position output at the third instant (blocks 72, 74). At block 76, the position output is defuzzified to obtain the position of the object at the third time instant. In this embodiment, the inference process can be done using Mamdani model. Further, mean of max defuzzification process can be utilized to obtain the position at the third instant. However, a plurality of other inference and defuzzification processes may be employed to obtain the position from the fuzzified position output at the third time instant. Examples include but are not limited to [Inventors: Please include alternative inference and defuzzification processes]

FIG. 3 is an illustrative polar position map 90 of a navigation space 92 of an example object. As illustrated, the navigation space 90 is partitioned into a plurality of fuzzy subsets such as represented by reference numerals 94, 96, 98, 100 and 102 based upon the distance range and the angle of the object 18 with reference to the sensing device 12 (see FIG. 1). In the illustrated embodiment, the navigation space 92 is divided into seven fuzzy categories based upon the distance range and seven fuzzy categories based upon the angle of the object 18. Thus, in the illustrated example embodiment the navigation space 92 is partitioned into forty nine fuzzy subsets and wherein each sensed position of the object 18 characterized by a distance range and an angle of the object corresponds to one of these fuzzy subsets in the polar position map 90.

In an embodiment the navigation space 92 may be partitioned into a greater or a lesser number of fuzzy subsets based upon a desired quality of prediction and a computational complexity of the system. For example, the navigation space 92 may be divided into five fuzzy categories based upon the distance range and the angle of the object 18. In an another embodiment, the navigation space 92 may be divided into nine or more fuzzy categories based upon the distance ranges and fuzzy categories based upon the angle of the object 18.

Referring again to FIG. 3, the range distance data and the angle data may be characterized with variables in each of the range subsets. For example, the variables for the range subsets may be defined as Vvfar, Vfar, Far, Moderate, Near, Vnear, and Vvnear. Similarly, the variables for the angle subsets may be defined as Vvleft, Vleft, Left, Front, Right, Vright, and Vvright. The position of the object 18 within each of the plurality of fuzzy subsets is characterized by these variables. For example, if an object 18 is positioned in a fuzzy subset 102, the position of the object 18 may be represented as (Vvfar, Vvright). Similarly, the position of the object 18 may be represented using these variables in other fuzzy subsets.

In an embodiment, the distance range and angle information may be represented by a membership function. In one embodiment, a triangular membership function may be employed to represent the distance range and angle information. Examples of other membership functions include, but are not limited to, trapezoidal, Gaussian, bell shaped, polynomial-PI and sigmoidal functions.

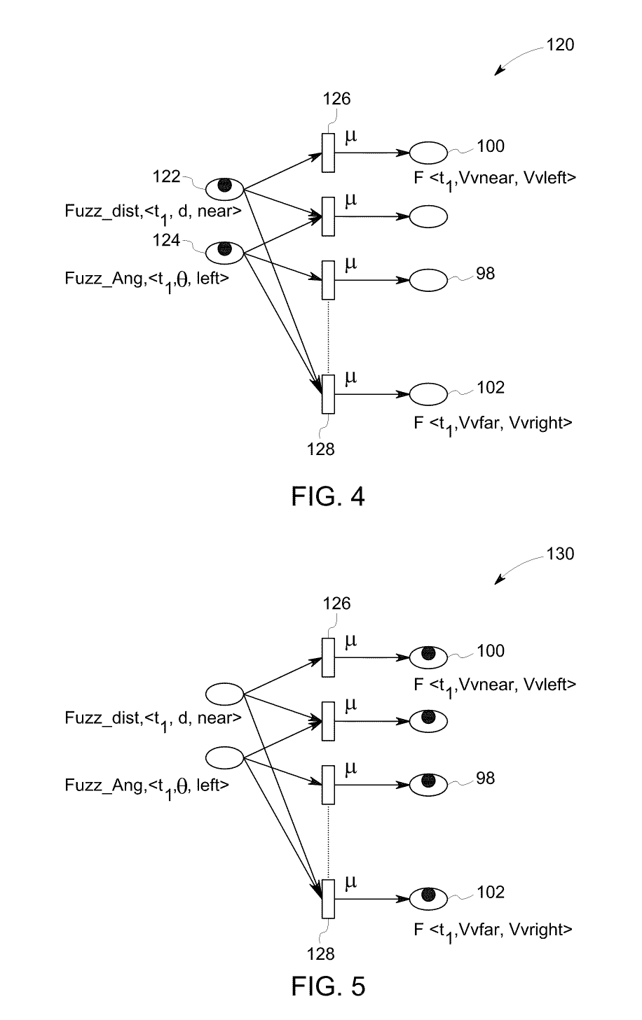

As described above, the sensed position estimates of the object 18 may be utilized to generate the fuzzy predictive rules for future position prediction of the object. In the illustrated embodiment, the sensed position estimates may be fuzzified using the distance range and the angle coordinates of the polar position map 90 of the navigation space 92 of the object 18. FIGS. 4 and 5 illustrate fuzzification of sensed position of an object using the polar position map 90 of FIG. 3.

FIG. 4 illustrates distance range and angle inputs 120 of an object at a first time instant (t1) before fuzzification of such inputs. In the illustrated embodiment, the range distance of an object with reference to the sensing device 12 (see FIG. 1) at the first time instant is represented by reference numeral 122. Further, the angle of the object of the object 18 with reference to the sensing device 12 at the first time instant is represented by reference numeral 124. The sensed range distance and the angle may correspond to any of the fuzzy subsets of the navigation space 92.

FIG. 5 illustrates the transition 130 of the input distance range 122 and the angle 124 after fuzzification using the fuzzy Petri nets. As illustrated, each of these distance range and angle inputs 122 and 124 categorize into one of fuzzy subsets such as represented by reference numeral 100 and 102 of the polar position map 90 after each transition represented generally by reference numerals 126 and 128. For example, the input distance range 122 and the angle 124 may correspond to the fuzzy subset represented by variables Vvnear, Vvleft (fuzzy subset 100) after the transition. It should be noted that the fuzzification of the distance range 122 and the angle inputs 124 may occur at a transition intensity that is based upon the distance of the sensed input with reference to a particular fuzzy subset of the navigation space 90.

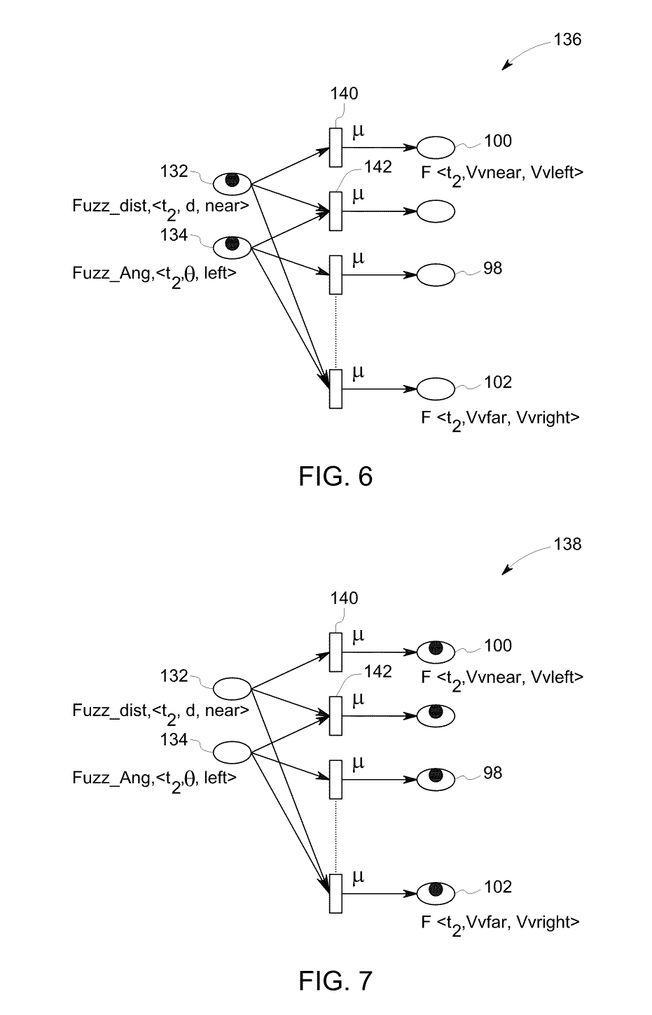

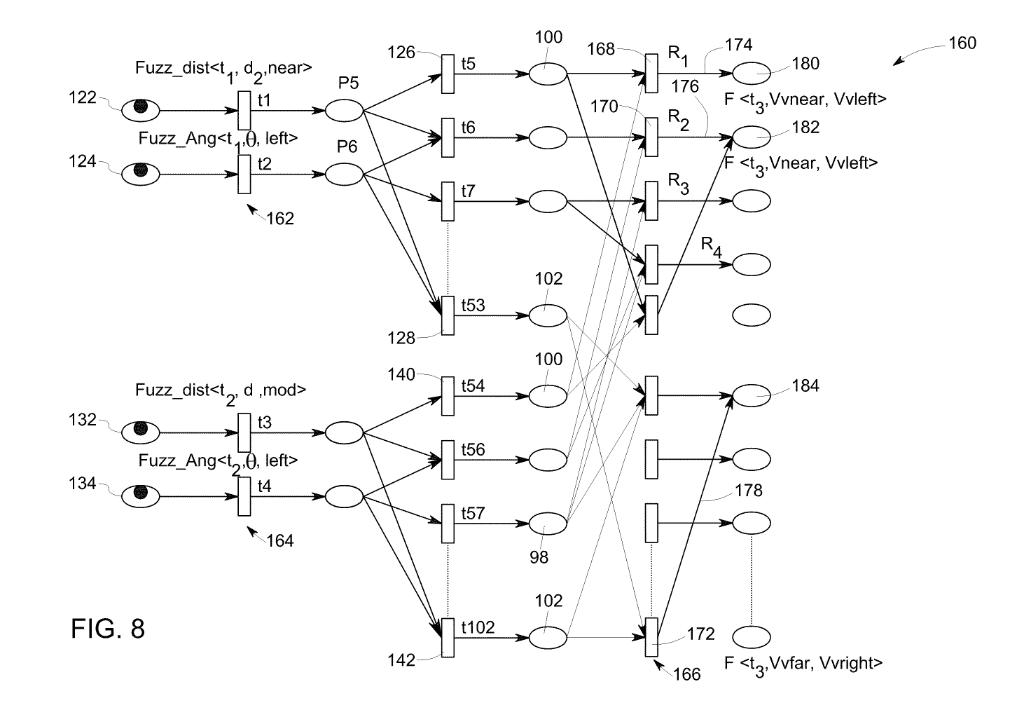

FIGS. 6 and 7 illustrate fuzzification of sensed position of the object 18 of FIG. 1 at a second time instant t2 using the polar position map 90 of FIG. 3. In this example embodiment, the first and second time instants are substantially equally spaced in time. As with the fuzzification transition at the first time instant t1, the distance range and angle inputs 132 and 134 shown in the configuration 136 correspond to fuzzy subsets such as represented by fuzzy subsets 98 and 100 as illustrated in configuration 138 after each transition 140 and 142 (FIG. 7).

In an embodiment, once the sensed inputs at first and second time points are fuzzified, these are utilized to generate fuzzy predictive rules for future motion prediction. The fuzzy predictive rule is generated using first and second sensed positions as antecedents and the third sensed position as a consequent of the fuzzy predictive rule. An example of a fuzzy predictive rule may be represented as:

[symbol]

(3)

Referring back to polar position map 90 of FIG. 3, the fuzzy predictive rule shown above may be represented by a trajectory 150. As illustrated, when the object sensed positions at first and second time instants correspond to the fuzzy subsets 94 and 96, then the predicted position of the object 18 at the third time instant corresponds to the fuzzy subset 98. Thus, based upon the fuzzy predictive rules and the object sensed positions from at least two time instants the object position at the next time instant may correspond to any of these subsets.

FIG. 8 is an illustrative embodiment of an example fuzzy Petri net model 160 for position prediction of the object 18 using the object position tracking system 10 of FIG. 1. In the illustrated embodiment, the antecedents of the fuzzy predictive rules generated through the sensed positions at first and second time instants are represented by reference numerals 162 and 164. The fuzzy Petri net model 160 includes a plurality of fuzzy predictive rules such as represented by a rule base 166 that includes transitions such as represented by reference numerals 168, 170 and 172 defined for predicting the position of the object based upon the antecedents 162 and 164. The consequents for each of these transitions are represented by reference numerals 174, 176 and 178. Furthermore, the predicted positions in the navigation environment 92 are represented by reference numerals 180, 182 and 184.

Thus, the future position of the object at any time instant may be predicted using the fuzzy predictive rules 166 using the sensed positions of the object as the antecedents 162 and 164. Such predicted positions correspond to a unique position in the polar position map 90 of the navigation space 92. It should be noted that though the examples provided here are for position prediction in a two-dimensional space, embodiments may be utilized in a three-dimensional space as well.

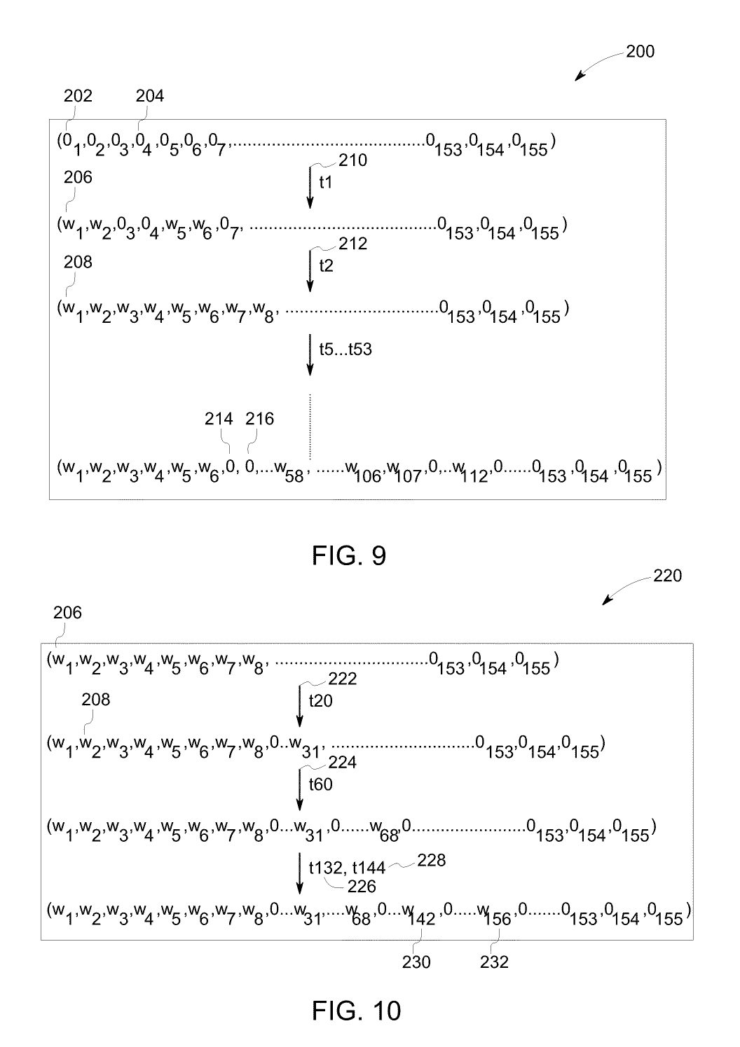

In certain example embodiments, the fuzzy predictive rules 166 can be refined to correct structural errors in the rules. In an embodiment, a reachability graph of the fuzzy Petri nets is employed to identify the structural errors. FIG. 9 illustrates an example of a reachability graph 200 for the navigation space 92 of FIG. 1 generated using the static Petri net model. In the illustrated embodiment, each node of the reachability graph such as represented by reference numerals 202, 204, 206 and 208 corresponds to a marking of the Petri net model. Further, each directed edge such as represented by reference numerals 210 and 212 represents transition firing and connects one node to another in the graph 200. Such reachability graph 200 is employed to identify the structural errors in the fuzzy predictive rules modeled using the Petri nets.

In one embodiment, the reachability graph 200 is employed to identify incomplete or missing fuzzy predictive rules. As used herein, the term “missing rules” refers to rules corresponding to never enabled transitions in the fuzzy Petri nets. In this embodiment, a zero in a terminal node of the reachability graph 200, such as represented by reference numerals 214 and 216 indicates missing rules.

In another embodiment, the reachability graph 200 is employed to identify inconsistent or conflicting fuzzy predictive rules. FIG. 10 illustrates another reachability graph 220 of the navigation space 92 for identifying the conflicting fuzzy predictive rules. As used herein, the term “conflicting fuzzy predictive rules” refers to rules that result in contradictory conclusions under a certain condition. As illustrated, after applying transitions t20 and t60 represented by reference numerals 222 and 224, the consequent transitions t132 and t144 represented by reference numerals 226 and 228 result in different markings w142 and w156 (represented by reference numerals 230 and 232) indicating inconsistency.

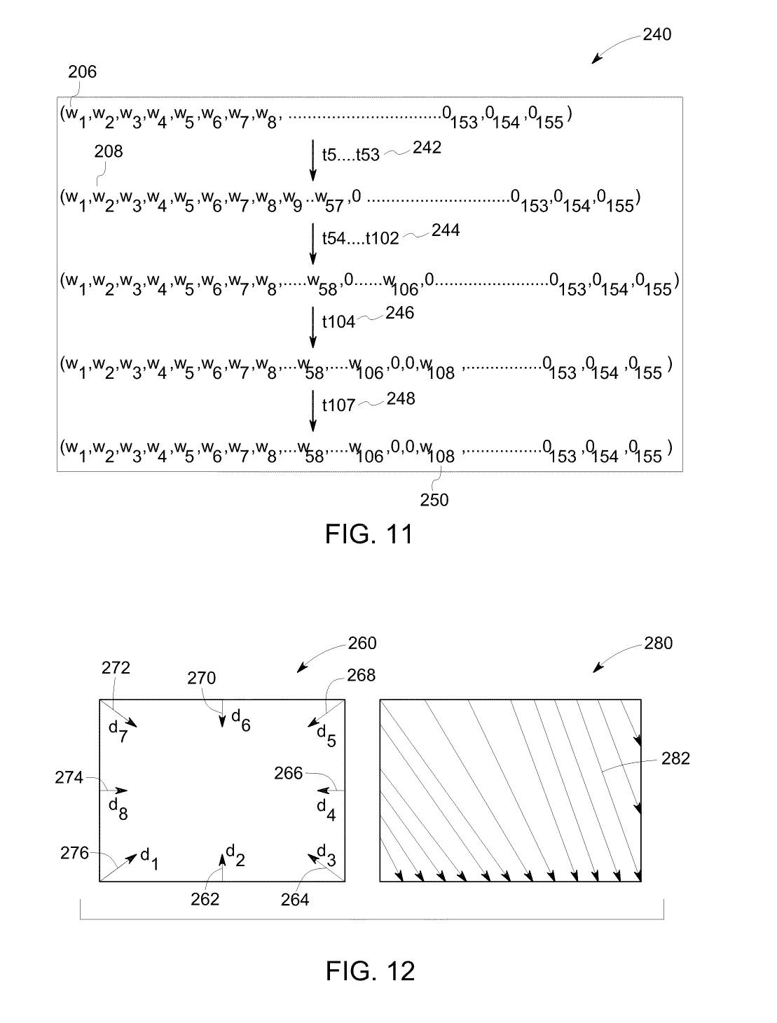

In another embodiment, the reachability graph may be employed to identify circular and redundant fuzzy predictive rules. FIG. 11 illustrates another reachability graph 240 of the navigation space 92 for identifying the redundant fuzzy predictive rules. The redundant rules may be identified if a marking for a transition is same as marking of a previous transition firing. For example, after applying transitions (t5 . . . t53) and (t54 . . . t102) generally represented by reference numerals 242 and 244, the consequent transitions t104 and t107 represented by reference numerals 246 and 248 result in same marking 250 (w108) indicating the redundancy in the rules.

In operation, once the structural errors such as inconsistent and redundant rules are identified, such errors can be corrected to generate optimized fuzzy predictive rules. In one embodiment, the inconsistent rules may be removed by partitioning the navigation space 92 as described below with reference to FIG. 12. The inconsistency in the rules may be due to a direction of traversal 20 (see FIG. 1) of the object 18.

FIG. 12 illustrates an example partitioned navigation space 260 that is tessellated in eight geographical directions 262, 264, 266, 268, 270, 272, 274, 276 and 278. In operation, sensed positions of the object 18 obtained at the first and second time instants form a trajectory in one of these directions. A separate directional space 280 is created for each of these eight directions 262, 264, 266, 268, 270, 272, 274, 276 and 278 and the fuzzy predictive rules are clustered based on the direction of traversal of the object 18. Further, based upon the direction of traversal, only those rules that belong to that directional space 280 are selected for processing the sensed inputs and predicting the future position of the object 18.

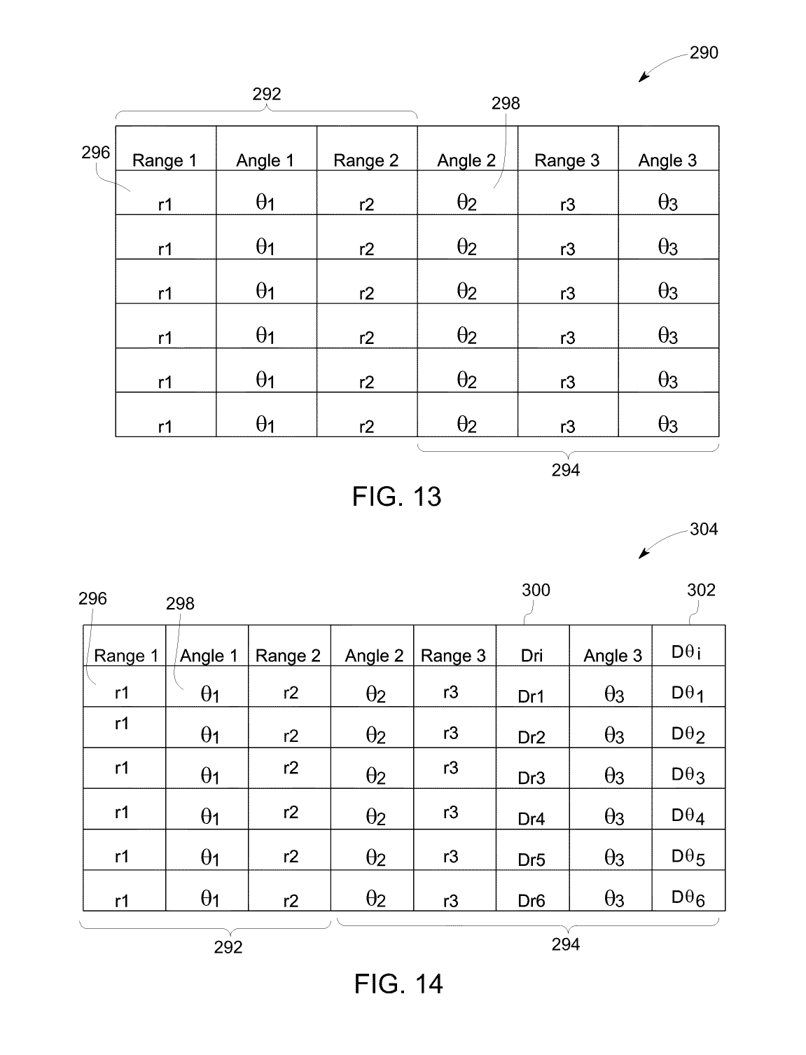

In another embodiment, a table look-up scheme is employed to alter or remove redundant and inconsistent fuzzy predictive rules. FIG. 13 is a table of antecedents 292 and consequents 294 for six fuzzy predictive rules with the distance range and angle values. Each of the antecedents 292 and consequents 294 include distance range and angles as represented by reference numerals 296 and 298. In this embodiment, all six predictive rules have same antecedents indicating inconsistency and redundancy in the rules. To remove such inconsistency, each rule is assigned a degree Drᵢ and Dθᵢ where:

[symbol]

(4)

and

[symbol]

(5)

where:

Drᵢ represents the degree of range distance; and

Dθᵢ represents the degree of angle;

[symbol] represent membership values of the range parameter observed at first and second time instants;

[symbol] represents membership value of the range of resulting consequent;

[symbol] represent membership values of the angle parameter observed at first and second time instants; and

[symbol] represents membership value of the angle of resulting consequent.

The redundant fuzzy predictive rules along with corresponding degrees 300 and 302 for the distance range and angles are illustrated in table 304 of FIG. 14.

Once the degrees of the distance range and angles are estimated, a reliability factor for each of the inconsistent rules is estimated to select the fuzzy predictive rules to be removed. The reliability factor is represented by the following equation:

$$R F = \frac{k 1}{k} \qquad ( 6 )$$

### Where:

RF is the reliability factor;

k1 is the total number of redundant rules; and

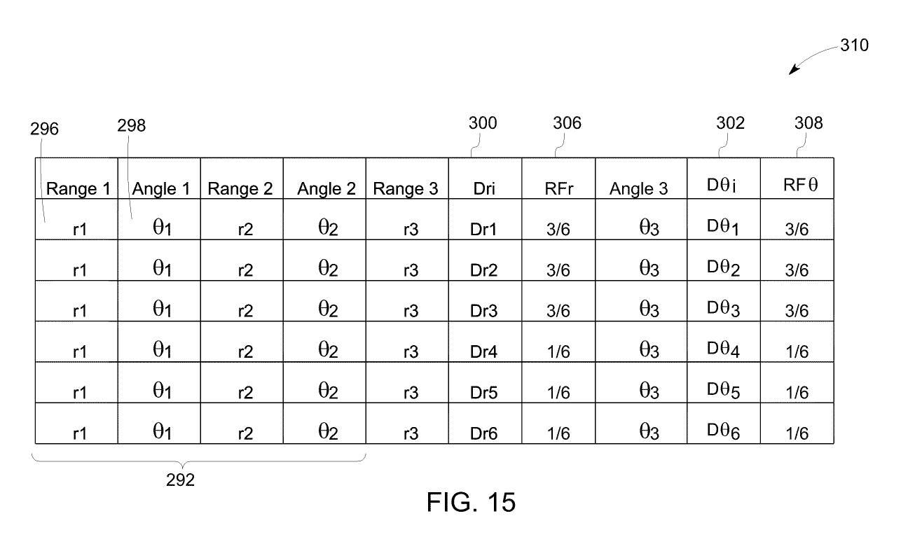

k is the total number of the redundant and inconsistent rules having the same antecedent part. The reliability factors for the inconsistent and redundant rules represented by reference numerals 306 and 308 in the table 310 of FIG. 15. Such reliability factors 306 and 308 are then used as weighting factors for computing the effective degree for each rule. The optimized rules are obtained by choosing the rules with the largest effective degrees for range and angle.

The optimized fuzzy predictive rules can subsequently be applied to at least two sensed positions to predict the position of the object at a future time instant. Further, the position output can be defuzzified to obtain the position at the future time instant.

The example methods and systems described above enable short term motion prediction in robot navigation environments. The methods and systems discussed herein utilize an efficient, reliable, and cost-effective technique for predicting future position of objects using fuzzy predictive rules in unknown environments. The use of fuzzy predictive rules can reduce the response time while facilitating simulation of real time situations.

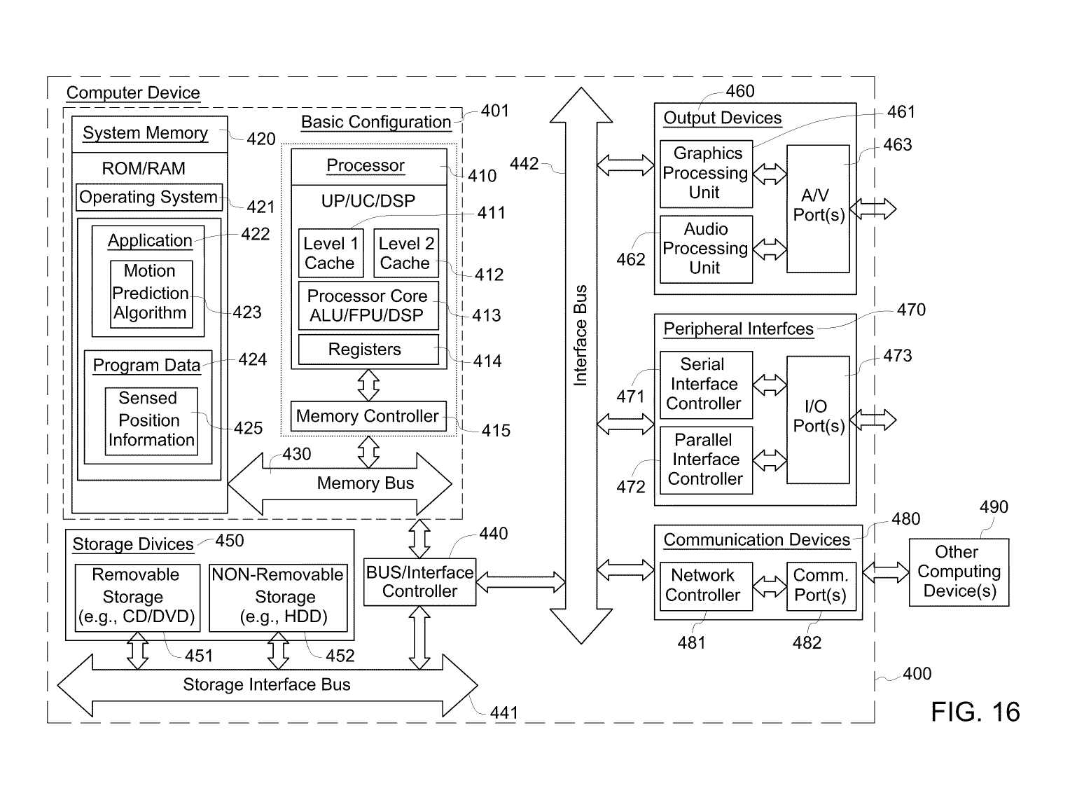

FIG. 16 is a block diagram illustrating an example computing device 400 that is arranged for short term motion prediction in accordance with the present disclosure. In a very basic configuration 401, computing device 400 typically includes one or more processors 410 and system memory 420. A memory bus 430 may be used for communicating between the processor 410 and the system memory 420.

Depending on the desired configuration, processor 410 may be of any type including but not limited to a microprocessor (μP), a microcontroller (μC), a digital signal processor (DSP), or any combination thereof. Processor 410 may include one more levels of caching, such as a level one cache 411 and a level two cache 412, a processor core 413, and registers 414. An example processor core 413 may include an arithmetic logic unit (ALU), a floating point unit (FPU), a digital signal processing core (DSP Core), or any combination thereof. An example memory controller 415 may also be used with the processor 410, or in some implementations the memory controller 415 may be an internal part of the processor 410.

Depending on the desired configuration, the system memory 420 may be of any type including but not limited to volatile memory (such as RAM), non-volatile memory (such as ROM, flash memory, etc.) or any combination thereof. System memory 420 may include an operating system 421, one or more applications 422, and program data 424. Application 422 may include a motion prediction algorithm 423 that is arranged to perform the functions as described herein including those described with respect to process 50 of FIG. 2. Program Data 424 may include sensed position information 425 of an object at previous time instants that may be useful for prediction of the future position of the object as will be further described below. In some embodiments, application 422 may be arranged to operate with program data 424 on an operating system 421 such that prediction of position of the object using the fuzzy predictive rules may be performed. This described basic configuration is illustrated in FIG. 16 by those components within dashed line 401.

Computing device 400 may have additional features or functionality, and additional interfaces to facilitate communications between the basic configuration 401 and any required devices and interfaces. For example, a bus/interface controller 440 may be used to facilitate communications between the basic configuration 401 and one or more data storage devices 450 via a storage interface bus 441. The data storage devices 450 may be removable storage devices 451, non-removable storage devices 452, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 420, removable storage 451 and non-removable storage 452 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of device 400.

Computing device 400 may also include an interface bus 442 for facilitating communication from various interface devices (e.g., output interfaces, peripheral interfaces, and communication interfaces) to the basic configuration 401 via the bus/interface controller 440. Example output devices 460 include a graphics processing unit 461 and an audio processing unit 462, which may be configured to communicate to various external devices such as a display or speakers via one or more A/V ports 463. Example peripheral interfaces 470 include a serial interface controller 471 or a parallel interface controller 472, which may be configured to communicate with external devices such as input devices (e.g., keyboard, mouse, pen, voice input device, touch input device, etc.) or other peripheral devices (e.g., printer, scanner, etc.) via one or more I/O ports 473. An example communication device 480 includes a network controller 481, which may be arranged to facilitate communications with one or more other computing devices 490 over a network communication link via one or more communication ports 482.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of tracking an object, comprising:
obtaining sensed positions of the object at a plurality of time instants; and
predicting a future position of the object by applying fuzzy predictive rules to the sensed positions of the object obtained from at least two previous time instants.

2. The method of claim 1, wherein the at least two previous time instants are two substantially equal time instants.

3. The method of claim 1, further comprising generating the fuzzy predictive rules using the sensed position of the object at the plurality of time instants, and refining the plurality of fuzzy predictive rules by correcting structural errors in the fuzzy predictive rules.

4. The method of claim 3, comprising:
obtaining first and second sensed positions of the object with reference to a sensing device at first and second time instants respectively;
obtaining a third sensed position of the object at a third time instant; and
generating the fuzzy predictive rule using the first and second sensed positions as antecedents and the third sensed position as a consequent of the fuzzy predictive rule.

5. The method of claim 4, wherein each of the first, second and third sensed positions comprises a distance range and an angle of the object with reference to the sensing device.

6. The method of claim 4, further comprising partitioning a navigation space of the object into a plurality of fuzzy subsets based upon the distance range and the angle, wherein each of the first second and third sensed positions corresponds to one of the plurality of range and angle subsets.

7. The method of claim 3, further comprising:
identifying the structural errors in the plurality of fuzzy predictive rules using fuzzy Petri nets; and
correcting the identified structural errors in the plurality of fuzzy predictive rules to generate optimized fuzzy predictive rules.

8. The method of claim 7, wherein identifying the structural errors comprises identifying at least one of missing fuzzy predictive rules, conflicting fuzzy predictive rules, circular fuzzy predictive rules and redundant fuzzy predictive rules via a reachability graph of the fuzzy Petri net.

9. The method of claim 8, further comprising selectively partitioning the navigation space of the object to alter or remove identified conflicting fuzzy predictive rules.

10. The method of claim 8, further comprising estimating a reliability factor for each of the identified conflicting and redundant fuzzy predictive rules and removing conflicting and redundant fuzzy predictive rules based upon the estimated reliability factor.

11. The method of claim 1, wherein predicting the position of the object comprises defuzzifying a position output obtained by applying the fuzzy predictive rules to the sensed position obtained from at least two previous time instants.

12. A method of tracking an object, comprising:
generating a plurality of fuzzy predictive rules using sensed positions of the object at a plurality of time instants;
optimizing the plurality of fuzzy predictive rules by removing or altering at least one of missing fuzzy predictive rules, conflicting fuzzy predictive rules, circular fuzzy predictive rules and redundant fuzzy predictive rules to generate optimized fuzzy predictive rules;
obtaining first and second sensed positions of the object at first and second time instants; and
predicting the position of the object at a third time instant by applying the optimized fuzzy predictive rules to the first and second sensed positions.

13. The method of claim 12, wherein each of the first, second and third sensed positions comprises a distance range and an angle of the object with reference to a sensing device.

14. The method of claim 12, wherein optimizing the plurality of fuzzy predictive rules comprises:
characterizing the plurality of fuzzy predictive rules using fuzzy Petri nets;
identifying the at least one of missing fuzzy predictive rules, conflicting fuzzy predictive rules, circular fuzzy predictive rules and redundant fuzzy predictive rules via a reachability graph of the fuzzy Petri nets; and
removing or altering the identified conflicting and redundant fuzzy predictive rules by selectively partitioning the navigation space of the object or by using a reliability factor in a table-lookup operation.

15. The method of claim 12, further comprising defuzzifying a position output at the third time instant.

16. An object position tracking system, comprising:
a sensing device configured to obtain a plurality of sensed positions of an object in an environment;
a memory circuit configured to store a plurality of fuzzy predictive rules for estimation of future positions of the object based upon the sensed positions; and
a processor configured to predict the future position of the object by applying the fuzzy predictive rules to sensed positions of the object for at least two previous time instants.

17. The object position tracking system of claim 16, further comprising a simulator configured to receive sensed positions of the object and to generate the fuzzy predictive rules from the sensed positions.

18. The object position tracking system of claim 16, further comprising a plurality of sensors disposed at multiple locations to sense the position of the object within the environment.

19. The object position tracking system of claim 16, wherein the sensing device comprises a stereo vision based sensor.

20. The object position tracking system of claim 16, wherein the processor is configured to develop a polar position map of a navigation space of the object wherein each sensed position is characterized by a distance range and an angle of the object in the polar position map.
